(19) United States
(12) Patent Application Publication
(10) Pub. No.: US 2006/0012618 A1
(43) Pub. Date: Jan. 19, 2006

(54) Method and apparatus for adjusting the alignment of printing

(75) Inventors: Hyun-jun Lee, Suwon-si (KR); Sang-hyup Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/180,994

(22) Filed: Jul. 14, 2005

(30) Foreign Application Priority Data
Jul. 16, 2004 (KR) 2004-0055477
Oct. 11, 2004 (KR) 2004-0081085

(51) Int. Cl. B41J 29/38

(52) U.S. Cl. 347/5

(57) ABSTRACT

Provided are a method and apparatus for adjusting the alignment between a first media surface and a second media surface in a printing device that prints by heating the first and second media surfaces using a single thermal head. The method includes the operations of printing a first pattern on the first surface of the medium by heating the first surface at first intervals using the thermal head, printing a second pattern on the second surface of the medium by heating the second surface at second intervals using the thermal head, detecting an overlapping print position where the first pattern completely overlaps the second pattern, calculating a distance deviation between a print position of the first surface and a print position of the second surface using the overlapping print position, and adjusting the print position of either of the first and second surfaces of the medium based on the calculated distance deviation.

### PRIORITY

This application claims the benefit under 35 U.S.C. §119(a) of Korean Patent Application Nos. 10-2004-0055477, filed on Jul. 16, 2004, and 10-2004-0081085, filed on Oct. 11, 2004, respectively, in the Korean Intellectual Property Office, the entire disclosures of which are hereby incorporated by reference.

### BACKGROUND OF THE INVENTION

1. Field of the Invention

The present invention relates to a printing device using a thermal head, and more particularly, to a method and apparatus for adjusting the alignment between a first media surface and a second media surface in a printing device that prints by heating the first and second media surfaces using a single thermal head.

2. Description of the Related Art

A thermal printing device transfers ink to a medium by heating an ink ribbon contacting the medium with a thermal head or heating a medium having an ink layer revealing a predetermined color in response to the heat from the thermal head, thereby forming an image.

FIG. 1 illustrates a sectional view of a conventional thermal-reactive medium. The conventional thermal-reactive medium has ink layers with predetermined color on both surfaces, a first surface 10a and a second surface 10b, respectively, of a base sheet 11. The ink layers include different color layers. For example, a yellow (Y) layer and a magenta (M) layer are sequentially stacked on the first surface 10a, and a cyan (C) layer is formed on the second surface 10b. The base sheet 11 may be transparent. A reflective layer 13 reflects light to show a color image on the first surface 10a.

FIG. 2 illustrates a sectional view of a conventional printing device using a thermal head. The conventional printing device includes a thermal-reactive medium 200, a driving roller 210, a driven roller 220, a platen roller 230, and a thermal head 240.

The driving roller 210 engages with a driving source, typically a motor (not shown) and rotates, thereby feeding the thermal-reactive medium 200. The driven roller 220 engages with the driving roller 210 and rotates such that the medium 200 passes therebetween.

The thermal head 240 heats the thermal-reactive medium 200 to print yellow, magenta and cyan data. The platen roller 230 faces the thermal head 240 such that the medium 200 is supported therebetween, thereby allowing ink to be fused to the medium 200. The platen roller 230 is rotated by the feeding of the medium 200.

In order to print an image by heating the first and second surfaces of the medium 200 using the thermal head 240, the thermal head 240 is moved to face the second surface of the medium after heating the first surface of the medium 200, or the medium 200 is fed so that the second surface of the medium 200 faces the thermal head 240 after the first surface thereof is heated.

As described above, when an image is printed by heating the opposing first and second surfaces of a medium using a single thermal head, the printing position of the first surface and the printing position of the second surface may not be exactly the same due to differences between the feed path of the first surface and the feed path of the second surface or due to a deviation in the mechanics of the printing device. As a result, the color desired for an image may not be printed on the medium.

### SUMMARY OF THE INVENTION

The present invention provides a method and apparatus for conveniently and accurately adjusting the alignment between the opposing first and second surfaces of a medium by detecting a distance deviation between the printing position of the first surface and the printing position of the second surface based on patterns respectively printed on the first and second surfaces and by adjusting either of the printing positions based on the detected distance deviation.

According to an aspect of the present invention, there is provided a method of adjusting the alignment of a printing device which prints by heating a first surface and a second surface of a medium using a thermal head, including the operations of (a) printing a first pattern on the first surface of the medium by heating the first surface at first intervals using the thermal head, (b) printing a second pattern on the second surface of the medium by heating the second surface at second intervals using the thermal head, (c) detecting an overlapping print position where the first pattern completely overlaps the second pattern; (d) calculating a distance deviation between a print position of the first surface and a print position of the second surface using the overlapping print position; and (e) adjusting the print position of either of the first and second surfaces of the medium based on the calculated distance deviation.

Operation (a) may comprise the operations of (a1) feeding the medium until an edge detection sensor detects an edge of the medium, (a2) further feeding the medium by a predetermined distance and heating the first surface of the medium using the thermal head to print a predetermined image, and (a3) feeding the medium and heating the first surface of the medium at increasing distance intervals a predetermined number of times, thereby printing the first pattern.

Operation (b) may comprise the operations of (b1) rotating the thermal head so that the thermal head faces the second surface of the medium, (b2) feeding the medium until an edge detection sensor detects an edge of the medium, (b3) further feeding the medium by a predetermined distance and heating the second surface of the medium using the thermal head to print a predetermined image, and (b4) feeding the medium and heating the second surface of the medium at increasing distance intervals a predetermined number of times, thereby printing the second pattern.

Operation (c) may comprise the operations of (c1) extracting image data from an image printed on the medium using a sensor, and (c2) comparing values of the image data and detecting the overlapping print position where the first pattern completely overlaps the second pattern. Operation (c2) may further comprise the operation of detecting a print position of a black image.

Operation (d) may comprise the operations of (d1) calculating a distance between the overlapping print position and a print start position of the first surface of the medium, (d2) calculating a distance between the overlapping print position and a print start position of the second surface of the medium, and (d3) calculating a difference between the distance calculated in operation (d1) and the distance calculated in operation (d2).

According to another aspect of the present invention, there is provided an apparatus for adjusting the alignment of a printing device which prints by heating a first surface and a second surface of a medium using a thermal head, comprising a pattern printing unit for respectively printing a first pattern and a second pattern on the first and second surfaces of the medium, a position detection unit for detecting an overlapping print position where the first pattern completely overlaps the second pattern, a deviation calculation unit for calculating a distance deviation between a print position of the first surface and a print position of the second surface using the overlapping print position, and an adjustor for adjusting a print position of either of the first and second surfaces of the medium based on the distance deviation.

The pattern printing unit may comprise a feeder for feeding the medium, the thermal head for printing an image by heating the first and second surfaces of the medium, an edge detection sensor for detecting an edge of the medium fed by the feeder, and a print controller for controlling the feeder and the thermal head to feed the medium by a predetermined distance from a position where the edge of the medium is detected by the edge detection sensor, to heat the medium to print a predetermined image, and to feed the medium and heat the medium at increasing distance intervals a predetermined number of times, thereby printing the first pattern on the first surface and the second pattern on the second surface. The apparatus may further comprise a position adjustor for rotating the thermal head so that the thermal head facing either of the first and second surfaces of the medium faces the other surface of the medium.

The position detection unit may comprise a sensor for detecting an image printed on the medium and outputting image data, an analog-to-digital converter for converting the image data from an analog form into a digital form, and a data comparator for comparing values of the digital image data and detecting an overlapping print position where the first pattern completely overlaps the second pattern. The data comparator may detect a print position of a black image. The sensor may be a reflective sensor.

The deviation calculation unit may comprise a memory section for storing print positions of the patterns printed on the first and second surfaces, respectively, of the medium, a memory controller for storing the print positions of the patterns printed on the first and second surfaces, respectively, of the medium in the memory section, a distance calculator for calculating a distance between the overlapping print position where the first and second patterns completely overlap and a print start position of the first surface that is stored in the memory and a distance between the overlapping print position where the first and second patterns completely overlap and a print start position of the second surface that is stored in the memory, and a difference calculator for calculating and outputting a difference between the two distances calculated by the distance calculator.

According to still another aspect of the present invention, there is provided a method for adjusting the alignment of a printing device, which uses a thermal head for heating a first surface and a second surface of a medium, in a direction perpendicular to a feed direction, the method comprising the operations of (a) printing a first pattern on the first surface of the medium by heating the first surface at predetermined intervals using a predetermined heating element from among a plurality of heating elements included in the thermal head while feeding the medium; (b) printing a second pattern on the second surface of the medium by heating the second surface at the predetermined intervals using heating elements at different positions from among the plurality of heating elements included in the thermal head while feeding the medium; (c) detecting an overlapping print position where the first pattern completely overlaps the second pattern; (d) calculating a distance deviation between a print position of the first surface and a print position of the second surface using the overlapping print position; and (e) adjusting the print position of either of the first and second surfaces of the medium based on the calculated distance deviation.

Operation (c) may comprise the operations of (c1) extracting image data from an image printed on the medium using a sensor, and (c2) comparing values of the image data and detecting the overlapping print position where the first pattern completely overlaps the second pattern. Operation (c2) may further comprise the operation of detecting a print position of a black image.

Operation (d) may comprise the operation of calculating a distance between a position of the predetermined heating element heating the first surface of the medium and a position of a heating element heating the second surface of the medium at the overlapping print position.

According to yet another aspect of the present invention, there is provided an apparatus for adjusting the alignment of a printing device, which uses a thermal head for heating a first surface and a second surface of a medium, in a direction perpendicular to a feed direction, the apparatus comprises a feeder for feeding the medium, the thermal head printing an image by heating the first and second surfaces of the medium, print controller for controlling the feeder and the thermal head to heat at predetermined intervals the first surface of the medium using a predetermined heating element from among a plurality of heating elements included in the thermal head and to heat at the predetermined intervals the second surface of the medium using heating elements at different positions among the plurality of heating elements included in the thermal head, thereby printing a first pattern on the first surface and a second pattern on the second surface, a position detection unit for detecting an overlapping print position where the first pattern completely overlaps the second pattern, a deviation calculation unit for calculating a distance deviation between a print position of the first surface and a print position of the second surface using the overlapping print position, and an adjustor for adjusting the print position of either of the first and second surfaces of the medium based on the distance deviation.

The position detection unit may comprise a sensor for detecting an image printed on the medium and outputting image data, and a data comparator for comparing values of the image data and detecting an overlapping print position where the first pattern completely overlaps the second pattern.

The data comparator may detect a print position of a black image.

The deviation calculation unit may comprise a memory section for storing positions of the heating elements used to print the first and second patterns on the medium, a memory controller for storing the positions of the heating elements used to print the first and second patterns on the medium in the memory section, and a distance calculator for reading from the memory section a position of the predetermined heating element for heating the first surface of the medium and a position of a heating element for heating the second surface of the medium at the overlapping print position, and calculating a distance between the two positions.

The method for adjusting the alignment in a printing device may be implemented by a computer-readable recording medium storing a program that is executed on a computer.

### BRIEF DESCRIPTION OF THE DRAWINGS

The above and other features and advantages of the embodiments of the present invention will become more apparent by describing in detail exemplary embodiments thereof with reference to the attached drawings in which:

FIG. 1 illustrates a sectional view of a conventional thermal-reactive medium;

FIG. 2 illustrates a sectional view of a conventional printing device using a thermal head;

FIG. 3 illustrates a sectional view of a printing device having a single thermal head adapted to operate according to an embodiment of the present invention;

FIG. 4 illustrates a sectional view of a printing device using a method for adjusting the alignment according to an embodiment of the present invention;

FIG. 5 is a block diagram of an apparatus for adjusting the alignment between media surfaces according to an embodiment of the present invention;

FIG. 6 is a detailed block diagram of an exemplary pattern printing unit shown in FIG. 5;

FIG. 7 is a detailed block diagram of an exemplary position detection unit shown in FIG. 5;

FIG. 8 is a detailed block diagram of an exemplary deviation calculation unit shown in FIG. 5;

FIG. 9 is a flowchart of a method for adjusting the alignment according to an embodiment of the present invention;

FIG. 10 is a detailed flowchart of operations for printing patterns on the first and second surfaces, respectively, of a medium in the embodiment illustrated in FIG. 9;

FIG. 11 is a detailed flowchart of an operation for detecting an overlapping printing position in the embodiment illustrated in FIG. 9;

FIG. 12 is a detailed flowchart of an operation for calculating a distance deviation in the embodiment illustrated in FIG. 9;

FIGS. 13A through 13E are diagrams for explaining the operations included in the method illustrated in FIG. 9;

FIG. 14 is a block diagram of an apparatus for adjusting the alignment according to another embodiment of the present invention;

FIG. 15 is a detailed block diagram of an exemplary position detection unit shown in FIG. 14;

FIG. 16 is a detailed block diagram of an exemplary deviation calculation unit shown in FIG. 14;

FIG. 17 is a flowchart of a method for adjusting the alignment according to another embodiment of the present invention;

FIG. 18 is a detailed flowchart of operations for printing a first pattern on a first surface of a medium according to the embodiment illustrated in FIG. 17;

FIG. 19 is a detailed flowchart of operations for printing a second pattern on a second surface of the medium according to the embodiment illustrated in FIG. 17;

FIG. 20 is a detailed flowchart of an operation for detecting a printing position where the first pattern and the second pattern meet each other in the embodiment illustrated in FIG. 17;

FIG. 21 is a detailed flowchart of an operation for calculating a distance deviation in the embodiment illustrated in FIG. 17; and

FIGS. 22A through 22E are diagrams for explaining the operations of an embodiment of the present invention illustrated in FIG. 17.

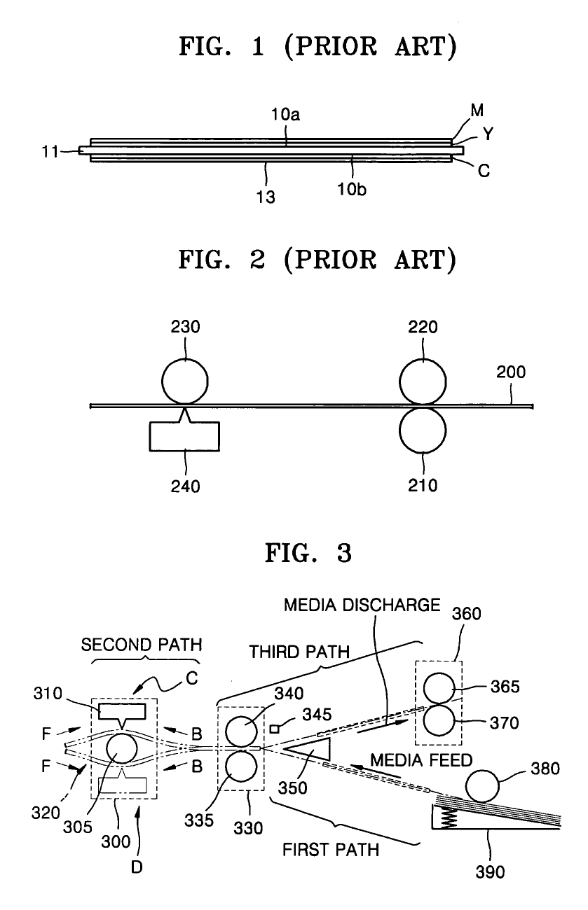

It should be understood that throughout the figures like reference numbers refer to like features, structures and elements.

### DETAILED DESCRIPTION OF EXEMPLARY EMBODIMENTS

Reference will now be made in detail to the exemplary embodiments of the present invention, examples of which are illustrated in the accompanying drawings, wherein like reference numerals refer to the like elements throughout. The embodiments are described below in detail in order to explain the embodiments of the present invention by referring to the figures.

FIG. 3 illustrates a sectional view of a printing device to explain the operation of the printing device using a single thermal head according to an embodiment of the present invention. The printing device includes a platen roller 305, a thermal head 310, a driving roller 335, a driven roller 340, an edge detection sensor 345, a media guide 350, a discharge driven roller 365, a discharge roller 370, a pickup roller 380, and a media reservoir 390.

A printing device using a single thermal head usually has at least three paths to feed a medium. The pickup roller 380 picks up a medium 320 from the media reservoir 390 and feeds the medium 320 through a first path. Through the second path, the medium 320 is fed in a reverse print direction (the B direction) to be positioned in a printing area and in a forward print direction (the F direction) to be printed by heat of the thermal head 310. The medium 320 is fed through a third path after a first surface of the medium 320 is heated for printing and before the medium 320 is fed in the B direction and returned to the second path. The medium 320 is fed along the third path to be finally discharged when it is fed in the F direction after printing is completed on both of the first and second surfaces thereof.

The media guide 350 may be provided between the first and third paths. The media guide 350 controls the medium 320 fed through the first path to advance to the second path and the medium 320 fed through the second path to advance to the third path.

In the second path, an image printing unit 300 performs the image printing. The image printing may be performed two times or more than two times when necessary. In the embodiments of the present invention, the image printing is preferably performed two times, once on the first surface and once on the second surface, of the medium 320.

Before image printing is performed on either of the first and second surfaces of the medium 320, the thermal head 310 is positioned for image printing. For example, when image printing is performed on the first surface of the medium 320, the thermal head 310 is positioned at a position D. When image printing is performed on the second surface of the medium 320, the thermal head 310 is positioned at a position C. The position of the thermal head 310 may be changed by rotating the platen roller 305 and the thermal head 310 around a rotational axis of the platen roller 305. The position of the thermal head 310 is changed when interference with the medium 320 does not occur, for example, before the medium 320 is fed from the first path or after the medium 320 whose first surface has been printed is fed to the third path before the medium 320 is returned to the second path.

After image printing is performed on the first surface of the medium 320, and when the medium 320 is fed from the third path back to the second path in the reverse print direction, image printing is performed on the second surface of the medium 320 using the thermal head 310 that has been rotated. During image printing, the medium 320 is gradually fed by a feeding unit 330 in the forward print direction (F). After, image printing is completed on the second surface of the medium 320, the medium 320 that is fed to the third path is discharged by a media discharging unit 360.

The edge detection sensor 345 detects an edge of the medium 320 fed by the feeding unit 330 and may be implemented by an optical sensor.

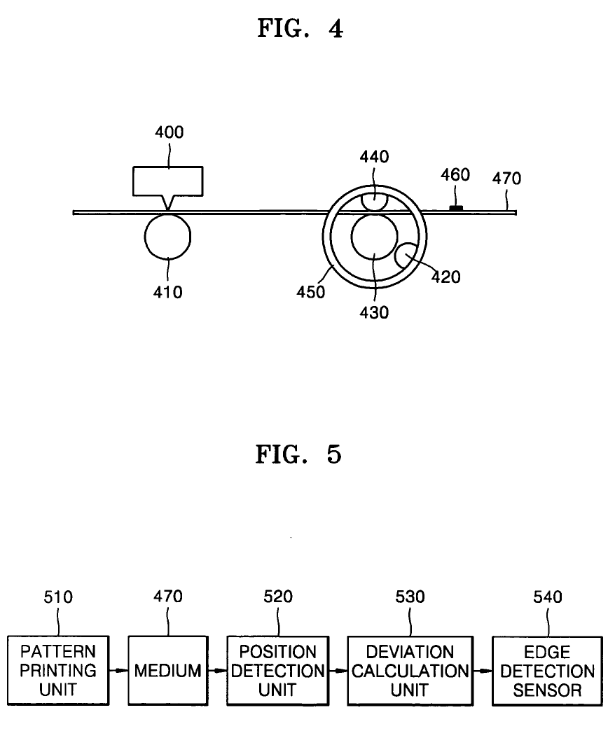

FIG. 4 illustrates a sectional view of a printing device using a method for adjusting the alignment according to an embodiment of the present invention. The printing device includes a thermal head 400, a platen roller 410, a motor 420, a driving roller 430, a driven roller 440, an encoder 450, and an edge detection sensor 460.

The thermal head 400 heats a medium 470 to print an image. The platen roller 410 fuses ink onto the medium 470 using heat from the thermal head 400. The motor 420 drives the driving roller 430 that feeds the medium 470 in a forward print direction and backward print direction. The edge detection sensor 460 detects an edge of the medium 470 and senses a position of the medium 470. The encoder 450 converts the operation of the driving roller 430 into an electrical signal to measure the feed distance or the feed speed of the medium 470. The encoder 450 may also be attached to the driven roller 440 or the motor 420 besides the driving roller 430 and may convert an operation of the driven roller 440 or the motor 420 into electrical signal to measure the feed distance or the feed speed of the medium 470.

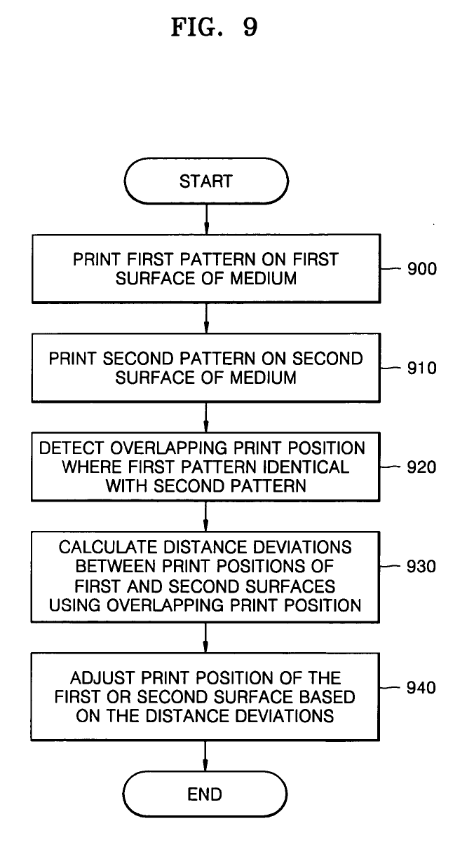

FIG. 5 is a block diagram of an apparatus for adjusting the alignment according to an embodiment of the present invention. The apparatus includes a pattern printing unit 510, a position detection unit 520, a deviation calculation unit 530, and an adjustor 540. The apparatus illustrated in FIG. 5 will be described with reference to a flowchart of a method for adjusting the alignment according to an embodiment of the present invention illustrated in FIG. 9.

In operation 900, the pattern printing unit 510 prints a first pattern on a first surface of the medium 470 by heating the first surface at regular or irregular intervals using the thermal head 400 while feeding the medium 470.

In operation 910, the pattern printing unit 510 prints a second pattern on a second surface of the medium 470 by heating the second surface at regular or irregular intervals using the thermal head 400 while feeding the medium 470.

In operation 920, the position detection unit 520 detects an overlapping print position where the first pattern printed on the first surface of the medium 470 completely overlaps the second pattern printed on the second surface thereof. In operation 930, the deviation calculation unit 530 calculates the distance deviations between the detected overlapping position and other print positions on the respective first and second surfaces of the medium 470.

In operation 940, the adjustor 540 adjusts the print position of either of the first and second surfaces of the medium 470 based on the distance deviations received from the deviation calculation unit 530. For example, when the print position of the first surface is ahead of the print position of the second surface by 0.1 mm, a print start position of the first surface may be moved back 0.1 mm or a print start position of the second surface may be moved forward 0.1 mm to adjust the alignment between the first and second surfaces of the medium 470 in a feed direction.

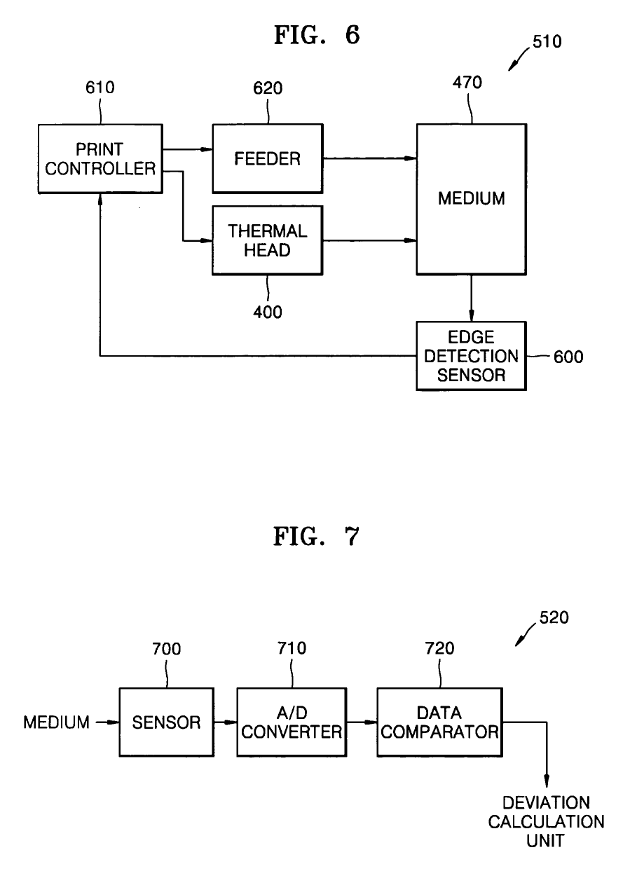

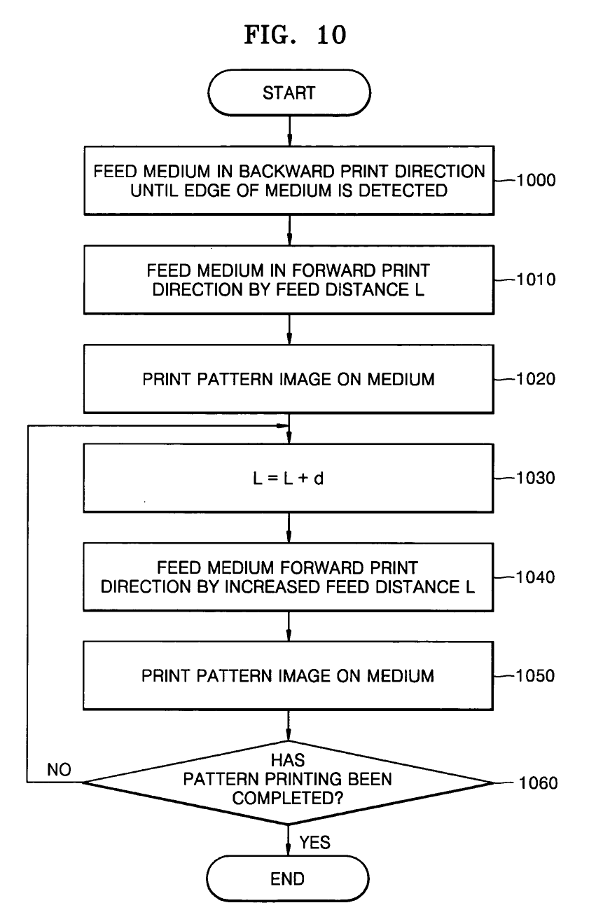

FIG. 6 is a detailed block diagram of the pattern printing unit 510 shown in FIG. 5. The pattern printing unit 510 comprises an edge detection sensor 600, a print controller 610, a feeder 620, and the thermal head 400. The pattern printing unit 510 illustrated in FIG. 6 will be described with reference to FIG. 10, which is a detailed flowchart of the operations of printing the first and second patterns on the first and second surfaces, respectively, of the medium 470 according to an embodiment of the present invention.

In operation 1000, the feeder 620 feeds the medium 470 in the backward print direction under the control of the print controller 610 until the edge detection sensor 600 detects an edge of the medium 470 fed by the feeder 620. The edge detection sensor 600 may be an optical sensor.

In operation 1010, under the control of the print controller 610, the feeder 620 feeds the medium 470 in the forward print direction by a feed distance L (not shown) from a position where the edge of the medium 470 has been detected. In operation 1020, the thermal head 400 heats the medium 470, thereby printing a pattern image.

In operation 1030, the print controller 610 increases the feed distance L by a predetermined value “d”. In operation 1040, under the control of the print controller 610, the feeder 620 feeds the medium 470 in the forward print direction by the increased feed distance L. In operation 1050, the thermal head 400 heats the medium, thereby printing a pattern image.

In operation 1060, the print controller 610 determines whether pattern printing has been completed and, if not, operations 1030 through 1050 are repeated until the pattern printing is completed.

When the first and second patterns are respectively printed on the first and second surfaces of the medium 470, the feed distance L by which the medium 470 is initially fed in the forward print direction in operation 1010 may be the same for both of the first and second surfaces, but the predetermined value “d” by which the feed distance L is increased in operation 1030 may be different for the first and second surfaces.

To print the second pattern on the second surface of the medium 470 after printing the first pattern on the first surface of the medium 470 using the thermal head 400, a position adjustor may be further provided to rotate the thermal head 400 to face either the first surface or second surface of the medium 470 to face the other surface.

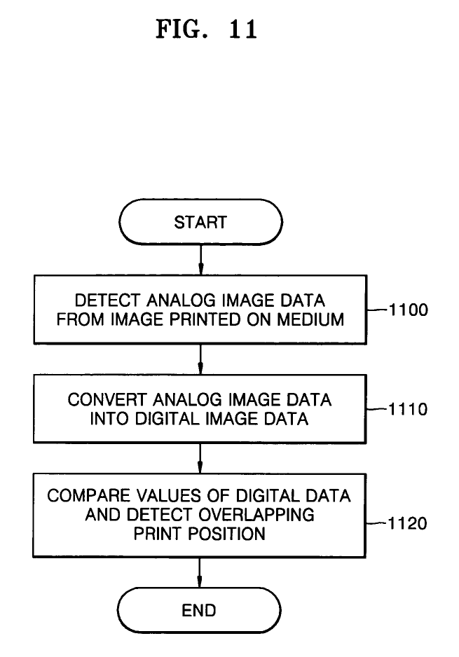

FIG. 7 is a detailed block diagram of the position detection unit 520 shown in FIG. 5. The position detection unit 520 comprises a sensor 700, an analog-to-digital (A/D) converter 710, and a data comparator 720. The operation of the position detection unit 520 illustrated in FIG. 7 will be described with reference to the flowchart illustrated in FIG. 11.

In operation 1100, the sensor 700 senses an image printed on the medium 470 and outputs image data. Here, the sensor 700 may be a reflective sensor. A single sensor may be commonly used as the edge detection sensor 600 and the sensor 700 detecting the image data.

In operation 1110, the A/D converter 710 converts the image data from an analog form into a digital form to generate digital data. In operation 1120, the data comparator 720 compares values of the digital data with each other and detects an overlapping print position where the first pattern on the first surface of the medium 470 completely overlaps the second pattern on the second surface thereof.

When the first and second patterns are respectively printed on the first and second surfaces of the medium 470 under the condition that the color depth of data printed on the first surface is the same as that of data printed on the second surface, a black image is formed at an overlapping print position where the first pattern on the first surface completely overlaps the second pattern on the second surface. Accordingly, the data comparator 720 may detect a data value corresponding to the color black from among the digital data values detected from the overlapping print position where the first pattern and the second pattern completely overlap. For example, when a yellow (Y) layer and a magenta (M) layer are sequentially formed on the first surface of the medium 470 and a cyan layer (C) is formed on the second surface of the medium 470, the image data may be set such that a black image is formed on the medium 470 when Y, M, and C are printed at the same position by the thermal head 400 and may be printed in a predetermined pattern on the medium 470.

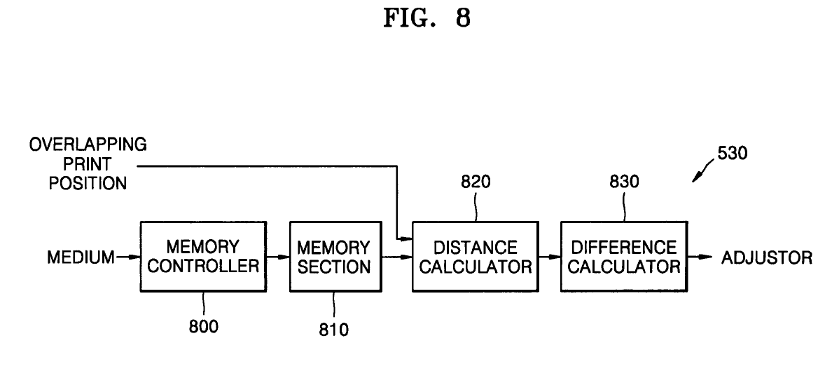

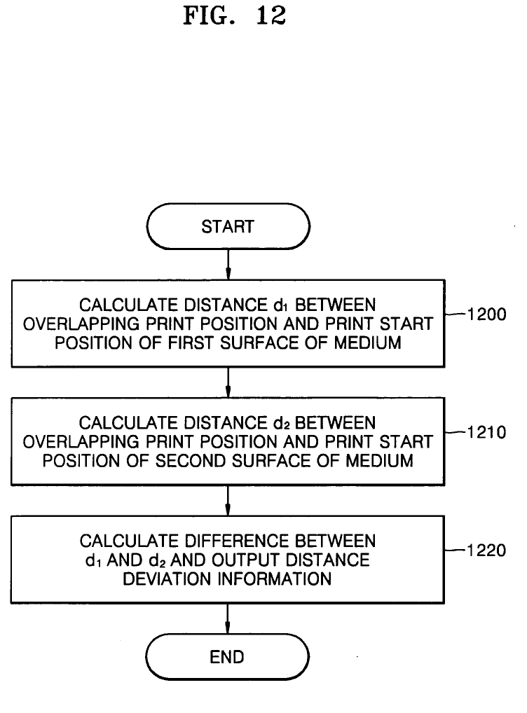

FIG. 8 is a detailed block diagram of the deviation calculation unit 530 shown in FIG. 5. The deviation calculation unit 530 comprises a memory controller 800, a memory section 810, a distance calculator 820, and a difference calculator 830. The operation of the deviation calculation unit 530 illustrated in FIG. 8 will be described with reference to a flowchart illustrated in FIG. 12. The memory controller 800 stores the print positions of the first and second patterns printed on the first and second surfaces, respectively, of the medium 470 in the memory section 810 in advance.

In operation 1200, the distance calculator 820 receives the overlapping print position, where the first and second patterns on the respective first and second surfaces of the medium 470 completely overlap, from the position detection unit 520 and a print start position of the first pattern on the first surface of the medium 470 from the memory section 810 and calculates a distance d₁ between the two positions.

In operation 1210, the distance calculator 820 calculates a distance d₂ between the overlapping print position received from the position detection unit 520 and a print start position of the second pattern on the second surface of the medium 470, which is received from the memory section 810.

In operation 1220, the difference calculator 830 calculates the difference between the calculated distances d, and d₂ and outputs information regarding a distance deviation between the print positions of the respective first and second surfaces of the medium 470. For example, when the distance d, is 31.4 mm and the distance d₂ is 31.1 mm, the difference calculator 830 outputs information indicating that the print position of the first surface of the medium 470 is ahead of the print position of the second surface thereof by the difference between d, and d₂, which is 0.3 mm.

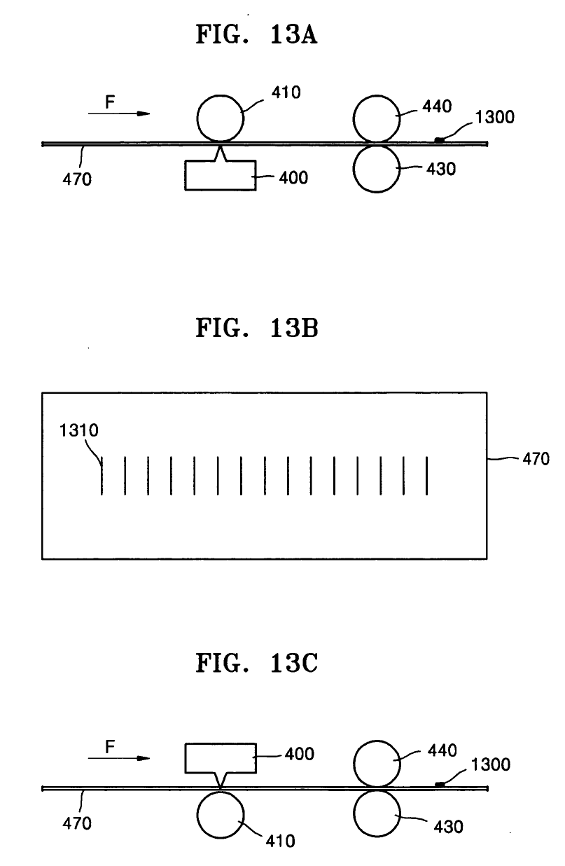

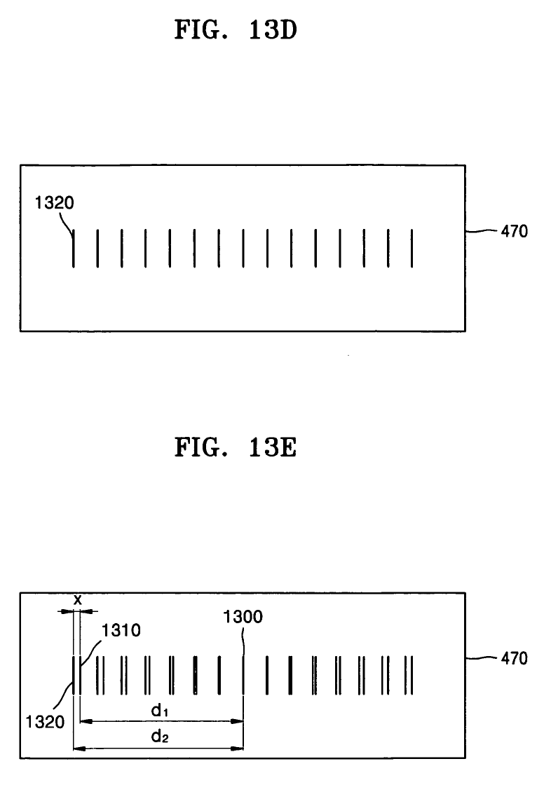

FIGS. 13A through 13E are diagrams for explaining the operations of the method illustrated in FIG. 9. Referring to FIG. 13A, after the feeder 620 (not shown) feeds the medium 470 in the backward print direction until the sensor 1300 detects an edge of the medium 470, the thermal head 400 applies heat at regular or irregular intervals to the first surface of the medium 470 that is being fed in the forward print direction (F) by the feeder 620, thereby printing the first pattern shown in FIG. 13B on the first surface of the medium 470.

After pattern printing is completed on the first surface of the medium 470, the thermal head 400 and the platen roller 410 are rotated so that the thermal head 400 faces the second surface of the medium 470.

Referring to FIG. 13C, after the feeder 620 feeds the medium 470 in the backward print direction until the sensor 1300 detects the edge of the medium 470, the thermal head 400 applies heat at regular or irregular intervals to the second surface of the medium 470 that is being fed in the forward print direction (F) by the feeder 620, thereby printing the second pattern shown in FIG. 13D on the second surface of the medium 470. Here, a print start position 1320 of the second pattern is set to be the same as a print start position 1310 of the first pattern.

FIG. 13E illustrates an image formed on the medium 470 after pattern printing on both of the first and second surface of the medium 470 is completed. The position detection unit 520 (not shown) detects an overlapping print position 1300 where the first pattern completely overlaps the second pattern. Then, the deviation calculation unit 530 calculates the distance d₁ between the overlapping print position 1300 and the print start position 1310 of the first surface and the distance d₂ between the overlapping print position 1300 and the print start position 1320 of the second surface and outputs a distance deviation (x) between the distances d₁ and d₂, which represented by the equation x=d₂−d₁.

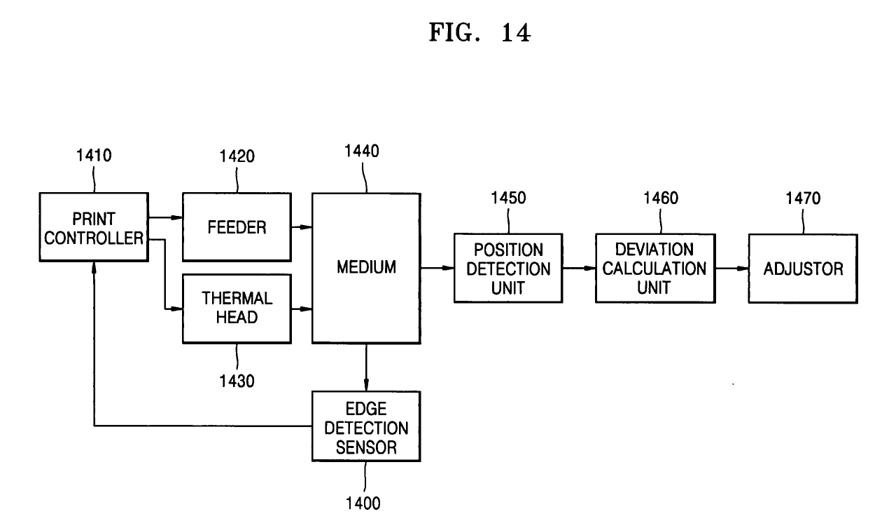

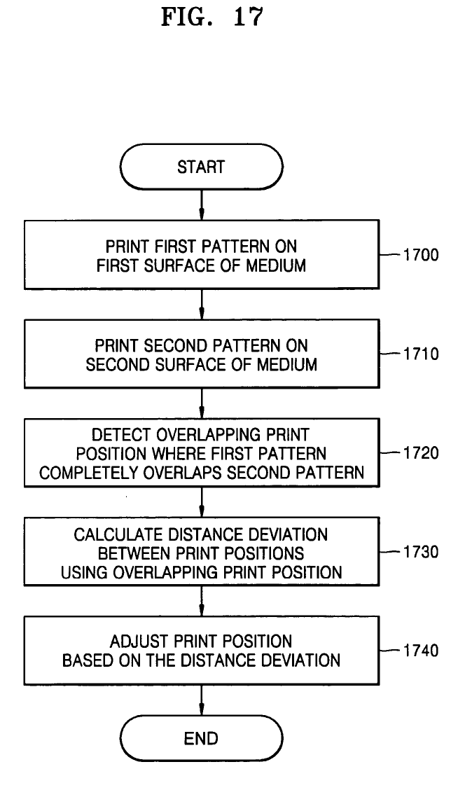

FIG. 14 is a block diagram of an apparatus for adjusting the alignment according to another embodiment of the present invention. The apparatus shown in FIG. 14 comprises an edge detection sensor 1400, a print controller 1410, a feeder 1420, a thermal head 1430, a position detection unit 1450, a deviation calculation unit 1460, and an adjustor 1470. The operations of the apparatus illustrated in FIG. 14 will be described with reference to a flowchart of a method for adjusting the alignment according to another embodiment of the present invention illustrated in FIG. 17

In operation 1700, the thermal head 1430 is controlled by the print controller 1410 to print a first pattern on a first surface of the medium 1440 fed by the feeder 1420 by heating the first surface at predetermined intervals using a single particular heating element from among a plurality of heating elements included therein.

In operation 1710, thermal head 1430 is controlled by the print controller 1410 to print a second pattern on a second surface of the medium 1440 fed by the feeder 1420 by heating the second surface at predetermined intervals using heating elements at different positions. Alternatively, the heating elements at different positions may be used to print the first pattern while a single particular heating element is used to print the second pattern. As another alternative, both of the first and second patterns may be printed using heating elements at different positions.

To print the second pattern on the second surface of the medium 1440 after printing the first pattern on the first surface of the medium 1440 using the thermal head 1430, a position adjustor (not shown) may be further provided to rotate the thermal head 1430 to face one of the first and second surfaces of the medium 1440 to face the other surface.

In operation 1720, the position detection unit 1450 detects a position where the first pattern printed on the first surface of the medium 1440 completely overlaps the second pattern printed on the second surface thereof. In operation 1730, the deviation calculation unit 1460 calculates a distance deviation between the print positions of the first and second surfaces of the medium 1440 using the overlapping print position.

In operation 1740, the adjustor 1470 adjusts the print position of either of the first and second surfaces of the medium 1440 based on the distance deviations received from the deviation calculation unit 1460. For example, when the print position of the first surface is deviated 0.1 mm to the left from the print position of the second surface, a print start position of the first surface may be moved 0.1 mm to the right or a print start position of the second surface may be moved 0.1 mm to the left to adjust alignment between the first and second surfaces of the medium 1440 in a direction perpendicular to the feed direction.

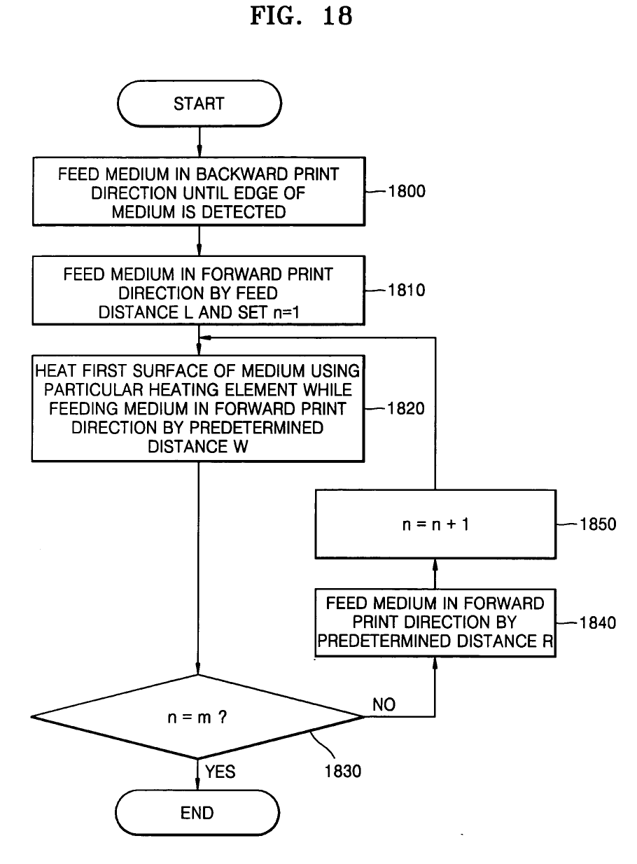

FIG. 18 is a detailed flowchart of the operations for printing the first pattern on the first surface of the medium 1440 in the embodiment illustrated in FIG. 17. In operation 1800, the edge detection sensor 1400 detects an edge of the medium 1440 fed by the feeder 1420 in a backward print direction. The edge detection sensor 1400 may be a reflective sensor.

In operation 1810, the feeder 1420 feeds the medium 1440 in a forward print direction by a predetermined distance L from the position where the edge of the medium 1440 has been detected. In addition, in operation 1810, “n”, which indicates the number of printed pattern images, is set to 1. In operation 1820, the medium 1440 is fed by the feeder 1420 by a predetermined distance W, during which the thermal head 1430 heats the first surface of the medium 1440 using a particular heating element from among the plurality of heating elements, thereby printing a pattern image with a length W.

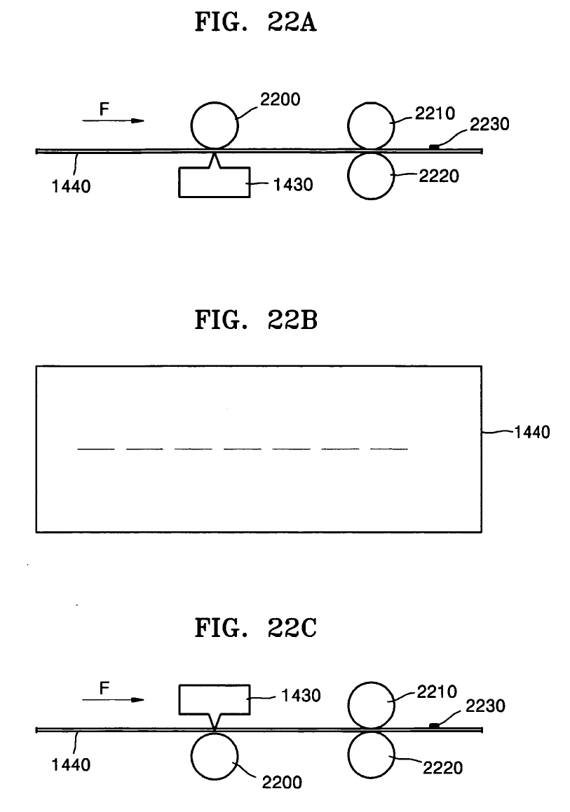

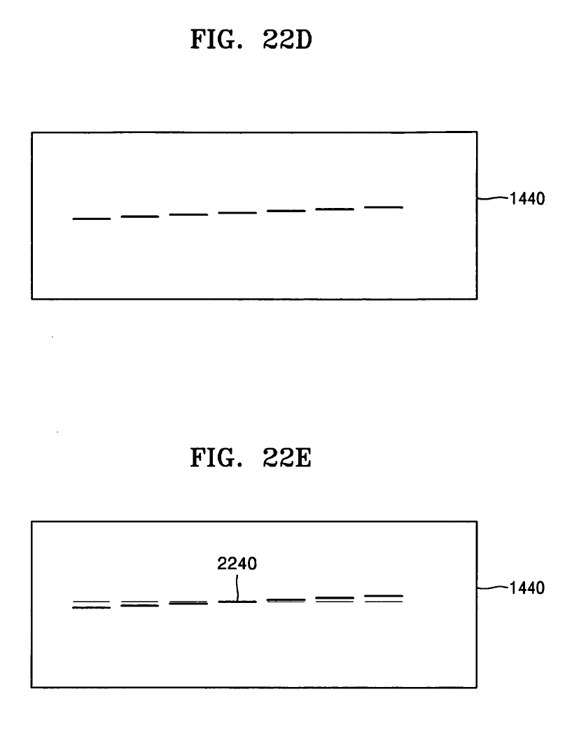

In operation 1830, it is determined whether “n” is equal to “m”, which indicates the predetermined number of pattern images to be printed on the medium 1440. When it is determined that “n” is not equal to “m”, the feeder 1420 feeds the medium 1440 in the forward print direction (F) by a predetermined distance R in operation 1840. Thereafter, in operation 1850, “n” is increased by 1, and operation 1820 is repeated. When it is determined that “n” is equal to “m” in operation 1830, the operations for printing the first pattern ends. When the first pattern is printed using the operations illustrated in FIG. 18, the first pattern appears on the first surface of the medium 1440 as shown in FIG. 22B.

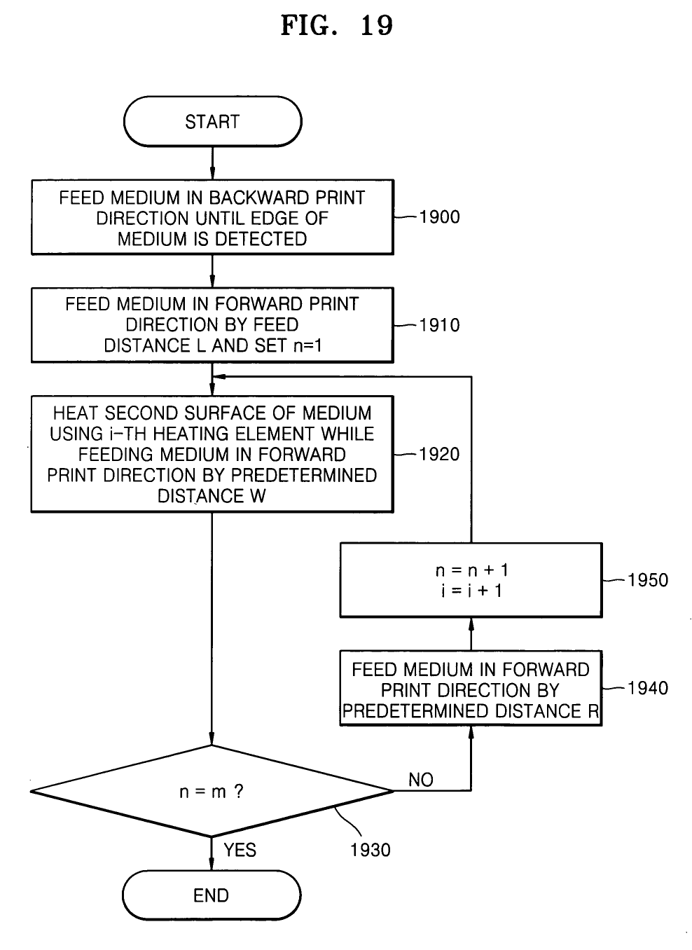

FIG. 19 is a detailed flowchart of the operations for printing the second pattern on the second surface of the medium 1440 in the embodiment illustrated in FIG. 17. In operation 1900, the edge detection sensor 1400 detects an edge of the medium 1440 fed by the feeder 1420 in the backward print direction. The edge detection sensor 1400 may be a reflective sensor.

In operation 1910, the feeder 1420 feeds the medium 1440 in the forward print direction by the predetermined distance L from the position where the edge of the medium 1440 has been detected. In addition, in operation 1910, “n”, which indicates the number of printed pattern images, is set to 1. In operation 1920, the medium 1440 is fed by the feeder 1420 by the predetermined distance W, during which the thermal head 1430 heats the second surface of the medium 1440 using an i-th heating element from among the plurality of heating elements, thereby printing a pattern image with the length W.

In operation 1930, it is determined whether “n” is equal to “m”, which indicates the predetermined number of pattern images to be printed on the medium 1440. When it is determined that “n” is not equal to “m”, the feeder 1420 feeds the medium 1440 in the forward print direction by the predetermined distance R in operation 1940. Thereafter, in operation 1950, “n” is increased by 1 and “i” is increased by 1 to select another heating element at a position shifted by 1 dot, and then operation 1920 is repeated. For example, if an initial pattern image is printed using a 300th heating element of the thermal head 1430, a subsequent pattern image may be printed using a subsequent 301st heating element so that print positions of adjacent pattern images are deviated 1 dot from each other in the second pattern.

When it is determined that “n” is equal to “m” in operation 1930, the operations for printing the second pattern ends. When the first pattern is printed using the operations illustrated in FIG. 19, the second pattern appears on the second surface of the medium 1440 as shown in FIG. 22D.

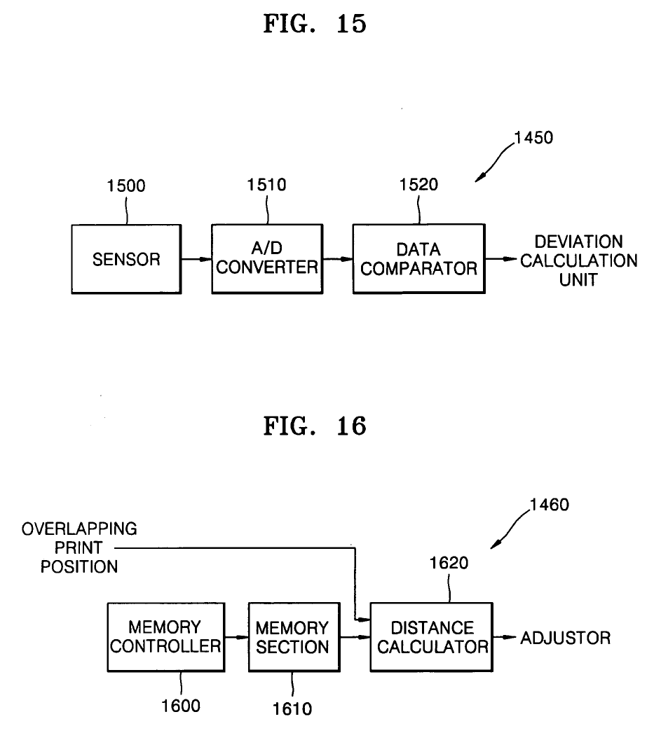

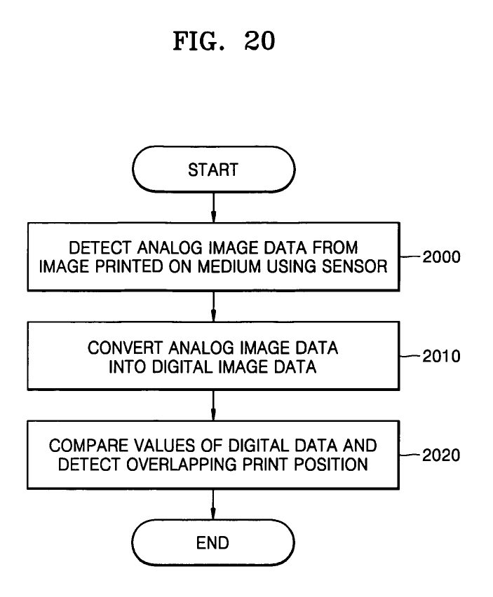

FIG. 15 is a detailed block diagram of the position detection unit 1450 shown in FIG. 14. The position detection unit 1450 comprises a sensor 1500, an A/D converter 1510, and a data comparator 1520. The operation of the position detection unit 1450 illustrated in FIG. 15 will be described with reference to the flowchart in FIG. 20.

In operation 2000, the sensor 1500 senses an image printed on the medium 1440 and outputs image data. Here, the sensor 1500 may be a reflective sensor. A single sensor may be used in common as the edge detection sensor 1400 and the sensor 1500 detecting the image data.

In operation 2010, the A/D converter 1510 converts the image data from an analog form into a digital form to generate digital data. In operation 2020, the data comparator 1520 compares values of the digital data with each other and detects an overlapping print position where the first pattern on the first surface of the medium 1440 completely overlaps the second pattern on the second surface thereof.

When the first and second patterns are respectively printed on the first and second surfaces of the medium 1440 under the condition that color depth of data printed on the first surface is the same as that of data printed on the second surface, a black image is formed at an overlapping print position where the first pattern on the first surface completely overlaps the second pattern on the second surface. Accordingly, the data comparator 1520 may detect a data value corresponding to the color black from among the digital data values detected from the overlapping print position where the first pattern and the second pattern completely overlap. For example, when a yellow (Y) layer and a magenta (M) layer are sequentially formed on the first surface of the medium 1440 and a cyan layer (C) is formed on the second surface of the medium 1440, the image data may be set such that a black image is formed on the medium 1440 when Y, M, and C are printed at the same position by the thermal head 1430 and may be printed in a predetermined pattern on the medium 1440.

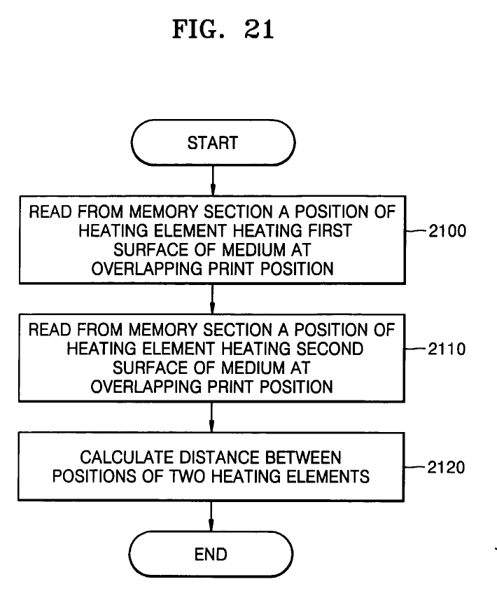

FIG. 16 is a detailed block diagram of the deviation calculation unit 1460 shown in FIG. 14. The deviation calculation unit 1460 comprises a memory controller 1600, a memory section 1610, and a distance calculator 1620. The operation of the deviation calculation unit 1460 illustrated in FIG. 16 will be described with reference to a flowchart in FIG. 21.

The memory controller 1600 stores the positions of the heating elements, which heat the medium 1440 to print patterns onto the first and second surfaces thereof, in the memory section 1610.

In operation 2100, the distance calculator 1620 receives from the position detection unit 1450 the overlapping print position, at which the first and second patterns on the respective first and second surfaces of the medium 1440 completely overlap, and reads from the memory section 1610 the position of the heating element heating the first surface of the medium 1440 at the overlapping print position.

In operation 2110, the distance calculator 1620 receives from the position detection unit 1450 the overlapping print position, at which the first and second patterns on the respective first and second surfaces of the medium 1440 completely overlap, and reads from the memory section 1610 the position of the heating element heating the second surface of the medium 1440 at the overlapping print position.

In operation 2120, the distance calculator 1620 calculates a distance between the positions of the two heating elements read from the memory section 1610 and outputs the distance. The distance between the positions of the two heating elements is the distance deviation between the print positions of the first and second surfaces of the medium 1440.

FIGS. 22A through 22E are diagrams for explaining the operations of the method according to an embodiment of the present invention illustrated in FIG. 17. Referring to FIG. 22A, after the feeder 1420 feeds the medium 1440 in the backward print direction until a sensor 2230 detects an edge of the medium 1440, the particular heating element of the thermal head 1430 heats at predetermined intervals the first surface of the medium 1440 that is being fed by the feeder 1420 in the forward print direction (F), thereby printing the first pattern, which is shown in FIG. 22B, on the first surface of the medium 1440.

After the printing of the first pattern on the first surface of the medium 1440 is completed, the thermal head 1430 and a platen roller 2200 are rotated so that the thermal head 1430 faces the second surface of the medium 1440.

Referring to FIG. 22C, after the feeder 1420 feeds the medium 1440 in the backward print direction until the sensor 2230 detects the edge of the medium 1440, the thermal head 400 heats at the predetermined intervals the second surface of the medium 1440 that is being fed by the feeder 1420 in the F direction, sequentially using heating elements at different positions that are separated by 1 dot from each other, thereby printing the second pattern, which is shown in FIG. 22D, on the second surface of the medium 1440.

FIG. 22E illustrates an image formed on the medium 1440 after pattern printing on both of the first and second surface of the medium 1440 is completed. The position detection unit 1450 detects the overlapping print position 2240 where the first pattern completely overlaps the second pattern. Then, the deviation calculation unit 1460 calculates a distance between the position of the heating element heating the first surface at the overlapping print position 2240 and the position of a heating element heating the second surface at the overlapping print position 2240 and outputs a distance deviation between the print positions of the first and second surfaces of the medium 1440, which is the distance between the two heating elements.

The invention can also be embodied as computer readable codes on a computer readable recording medium. The computer readable recording medium is any data storage device that can store data which can be thereafter read and executed by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for performing the functions of the embodiments of the present invention can be easily construed by programmers skilled in the art to which the present invention pertains.

As described above, according to an embodiment of the present invention, a distance deviation between a printing position of a first surface of a medium and a printing position of a second surface of the medium is detected based on patterns respectively printed on the first and second surfaces, and either of the printing positions is adjusted based on the detected distance deviation, thereby conveniently and accurately adjusting the alignment between the first and second surfaces of the medium While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method for adjusting the alignment of a printing device which prints by heating a first surface and a second surface of a medium using a thermal head, the method comprising the operations of:
(a) printing a first pattern on the first surface of the medium by heating the first surface at first intervals using the thermal head;
(b) printing a second pattern on the second surface of the medium by heating the second surface at second intervals using the thermal head;
(c) detecting an overlapping print position where the first pattern completely overlaps the second pattern;
(d) calculating a distance deviation between a print position of the first surface and a print position of the second surface using the overlapping print position; and
(e) adjusting the print position of either of the first and second surfaces of the medium based on the calculated distance deviation.

2. The method of claim 1, wherein operation (a) comprises the operations of:
(a1) feeding the medium until an edge detection sensor detects an edge of the medium;
(a2) further feeding the medium by a predetermined distance and heating the first surface of the medium using the thermal head to print a predetermined image; and
(a3) feeding the medium and heating the first surface of the medium at increasing distance intervals a predetermined number of times, thereby printing the first pattern.

3. The method of claim 1, wherein operation (b) comprises the operations of:
(b1) rotating the thermal head so that the thermal head faces the second surface of the medium;
(b2) feeding the medium until an edge detection sensor detects an edge of the medium;
(b3) further feeding the medium by a predetermined distance and heating the second surface of the medium using the thermal head to print a predetermined image; and
(b4) feeding the medium and heating the second surface of the medium at increasing distance intervals a predetermined number of times, thereby printing the second pattern.

4. The method of claim 1, wherein operation (c) comprises the operations of:
(c1) extracting image data from an image printed on the medium using a sensor; and
(c2) comparing values of the image data and detecting the overlapping print position where the first pattern completely overlaps the second pattern.

5. The method of claim 4, wherein operation (c2) comprises the operation of detecting a print position of a black image.

6. The method of claim 1, wherein operation (d) comprises the operations of:
(d1) calculating a distance between the overlapping print position and a print start position of the first surface of the medium;
(d2) calculating a distance between the overlapping print position and a print start position of the second surface of the medium; and
(d3) calculating a difference between the distance calculated in operation (d1) and the distance calculated in operation (d2).

7. A method for adjusting the alignment of a printing device, which uses a thermal head heating a first surface and a second surface of a medium, in a direction perpendicular to a feed direction, the method comprising the operations of:
(a) printing a first pattern on the first surface of the medium by heating the first surface at predetermined intervals using a predetermined heating element from among a plurality of heating elements included in the thermal head while feeding the medium;
(b) printing a second pattern on the second surface of the medium by heating the second surface at the predetermined intervals using heating elements at different positions among the plurality of heating elements included in the thermal head while feeding the medium;
(c) detecting an overlapping print position where the first pattern completely overlaps the second pattern;
(d) calculating a distance deviation between a print position of the first surface and a print position of the second surface using the overlapping print position; and
(e) adjusting the print position of either of the first and second surfaces of the medium based on the calculated distance deviation.

8. The method of claim 7, wherein operation (c) comprises the operations of:
(c1) extracting image data from an image printed on the medium using a sensor; and
(c2) comparing values of the image data and detecting the overlapping print position where the first pattern completely overlaps the second pattern.

9. The method of claim 8, wherein operation (c2) further comprises the operation of detecting a print position of a black image.

10. The method of claim 7, wherein operation (d) comprises the operation of calculating a distance between a position of the predetermined heating element heating the first surface of the medium and a position of a heating element heating the second surface of the medium at the overlapping print position.

11. An apparatus for adjusting the alignment of a printing device which prints by heating a first surface and a second surface of a medium using a thermal head, the apparatus comprising:
a pattern printing unit for respectively printing a first pattern and a second pattern on the first and second surfaces of the medium;
a position detection unit for detecting an overlapping print position where the first pattern completely overlaps the second pattern;
a deviation calculation unit for calculating a distance deviation between a print position of the first surface and a print position of the second surface using the overlapping print position; and
an adjustor for adjusting the print position of either of the first and second surfaces of the medium based on the distance deviation.

12. The apparatus of claim 11, wherein the pattern printing unit further comprises:
a feeder for feeding the medium;
the thermal head for printing an image by heating the first and second surfaces of the medium;
an edge detection sensor for detecting an edge of the medium fed by the feeder; and
a print controller for controlling the feeder and the thermal head to feed the medium by a predetermined distance from a position where the edge of the medium is detected by the edge detection sensor, to heat the medium to print a predetermined image, and to feed the medium and heat the medium at increasing distance intervals a predetermined number of times, thereby printing the first pattern on the first surface and the second pattern on the second surface.

13. The apparatus of claim 12, further comprising:
a position adjustor for rotating the thermal head so that the thermal head facing either of the first and second surfaces of the medium faces the other surface of the medium.

14. The apparatus of claim 11, wherein the position detection unit comprises:
a sensor for detecting an image printed on the medium and outputting image data;
an analog-to-digital converter for converting the image data from an analog form into a digital form; and
a data comparator for comparing values of the digital image data and detecting an overlapping print position where the first pattern completely overlaps the second pattern.

15. The apparatus of claim 14, wherein the data comparator detects a print position of a black image.

16. The apparatus of claim 14, wherein the sensor is a reflective sensor.

17. The apparatus of claim 11, wherein the deviation calculation unit comprises:
a memory section for storing print positions of the patterns printed on the first and second surfaces, respectively, of the medium;
a memory controller for storing the print positions of the patterns printed on the first and second surfaces, respectively, of the medium in the memory section;
a distance calculator for calculating a distance between the overlapping print position where the first and second patterns completely overlap and a print start position of the first surface that is stored in the memory and a distance between the overlapping print position where the first and second patterns completely overlap and a print start position of the second surface that is stored in the memory; and
a difference calculator for calculating and outputting a difference between the two distances calculated by the distance calculator.

18. An apparatus for adjusting the alignment of a printing device, which uses a thermal head for heating a first surface and a second surface of a medium, in a direction perpendicular to a feed direction, the apparatus comprising:
a feeder for feeding the medium;
the thermal head for printing an image by heating the first and second surfaces of the medium;
print controller for controlling the feeder and the thermal head to heat at predetermined intervals the first surface of the medium using a predetermined heating element among a plurality of heating elements included in the thermal head and to heat at the predetermined intervals the second surface of the medium using heating elements at different positions among the plurality of heating elements included in the thermal head, thereby printing a first pattern on the first surface and a second pattern on the second surface;
a position detection unit for detecting an overlapping print position where the first pattern completely overlaps the second pattern;
a deviation calculation unit for calculating a distance deviation between a print position of the first surface and a print position of the second surface using the overlapping print position; and
an adjustor for adjusting the print position of either of the first and second surfaces of the medium based on the distance deviation.

19. The apparatus of claim 18, wherein the position detection unit comprises:
a sensor for detecting an image printed on the medium and outputting image data; and
a data comparator for comparing values of the image data and detecting an overlapping print position where the first pattern completely overlaps the second pattern.

20. The apparatus of claim 19, wherein the data comparator detects a print position of a black image.

21. The apparatus of claim 18, wherein the deviation calculation unit comprises:
a memory section for storing positions of the heating elements used to print the first and second patterns on the medium;
a memory controller for storing the positions of the heating elements used to print the first and second patterns on the medium in the memory section; and
a distance calculator for reading a position of the predetermined heating element heating the first surface of the medium and a position of a heating element heating the second surface of the medium at the overlapping print position from the memory section and calculating a distance between the two positions.

22. A computer-readable recording medium storing a program for executing the operations of:
(a) printing a first pattern on the first surface of the medium by heating the first surface at first intervals using the thermal head;
(b) printing a second pattern on the second surface of the medium by heating the second surface at second intervals using the thermal head;
(c) detecting an overlapping print position where the first pattern completely overlaps the second pattern;
(d) calculating a distance deviation between a print position of the first surface and a print position of the second surface using the overlapping print position; and
(e) adjusting the print position of either of the first and second surfaces of the medium based on the calculated distance deviation.

23. A computer-readable recording medium storing a program for executing the operations of:
(a) printing a first pattern on the first surface of the medium by heating the first surface at predetermined intervals using a predetermined heating element from among a plurality of heating elements included in the thermal head while feeding the medium;
(b) printing a second pattern on the second surface of the medium by heating the second surface at the predetermined intervals using heating elements at different positions among the plurality of heating elements included in the thermal head while feeding the medium;
(c) detecting an overlapping print position where the first pattern completely overlaps the second pattern;
(d) calculating a distance deviation between a print position of the first surface and a print position of the second surface using the overlapping print position; and
(e) adjusting the print position of either of the first and second surfaces of the medium based on the calculated distance deviation.
